(19) United States
(12) Patent Application Publication
(10) Pub. No.: US 2023/0415533 A1
(43) Pub. Date: Dec. 28, 2023

(54) DURASTEER SUSPENSION SYSTEM FOR A THREE WHEELED VEHICLE

(71) Applicant: ev Transportation Services, Inc., Brookline, MA (US)

(72) Inventors: James Adams, Brookline, MA (US); Jared Aguillard, Brookline, MA (US)

(21) Appl. No.: 18/343,147

(22) Filed: Jun. 28, 2023

Related U.S. Application Data
(60) Provisional application No. 63/367,135, filed on Jun. 28, 2022.

(51) Int. Cl. B60G 3/14; B60G 7/00; B60G 7/02; B62D 1/16; B62D 61/08

(52) U.S. Cl. CPC B60G 3/14; B60G 7/001; B60G 7/008; B60G 7/02; B62D 1/16; B62D 61/08

(57) ABSTRACT

This disclosure describes a suspension system for a wheel on a three-wheeled vehicle. Specifically, a singular centrally mounted wheel can be mounted to the frame of a three-wheeled vehicle using the disclosed suspension system, which provides stable load bearing and pivoting of the wheel.

### CROSS-REFERENCE TO RELATED APPLICATIONS

This application claims priority under 35 U.S.C. § 119(e)(1) to U.S. Provisional Application No. 63/367,135, filed on Jun. 28, 2022, the contents of which are hereby incorporated by reference.

### BACKGROUND

Three-wheeled vehicles often include a singular wheel, in either the front or rear of the vehicle. This singular wheel can be subject to forces and loads that a wheel of a conventional four-wheeled vehicle might not experience. A suspension system for a three-wheeled vehicle transfers these loads to the frame of the vehicle while maintaining vehicle stability.

### SUMMARY

The present disclosure involves systems, and an apparatus for mounting a wheel on a three-wheeled vehicle, and providing a suspension system for that wheel.

In some implementations, the wheel mount system includes an arched brace having a first end, a second end, and an apex. A pivot tube is mounted proximal to the apex of the arched brace and defines a pivot axis. A wheel-mount arm including a wheel mount is coupled to the pivot tube, and configured to pivot about the pivot axis such that a wheel mounted to the wheel-mount will rotate about a wheel axis. A first mounting point is located at the first end of the arched brace and a second mounting point is located at the second end of the arch brace, the first and second mounting points are at the same height as, or lower than the wheel mount. A third mounting point is coupled to the arched brace between the first mounting point and the apex, and a fourth mounting point is coupled to the arched brace between the second mounting point and the apex. The third and fourth mounting points are configured to be coupled to shock absorbers and the first and second mounting points are configured to be pivotably coupled to the frame of a vehicle.

Implementations can optionally include one or more of the following features.

In some instances, the third and fourth mounting points are on outriggers mounted to the arched brace, and the suspension shock absorbers are mounted to the frame of the vehicle at locations higher than the first and second mounting points.

In some instances, the pivot tube includes a bearing configured to permit the wheel to pivot about the pivot axis. The bearing can be an angular contact bearing configured to withstand both axial and radial loads.

In some instances, the wheel is a front wheel and the vehicle is a three-wheeled vehicle.

In some instances, the wheel-mount arm is configured to engage a steering column mounted to the top of the pivot tube.

In some instances, the wheel-mount arm is a single sided mount-arm.

In some instances, the first and second mounting points define a suspension axis and the suspension axis is lower than, and behind the wheel axis relative to the vehicle frame.

In some instances, the pivot tube is supported by pivot bearings, and the pivot bearings are angled contact bearings.

In some instances, the wheel-mount arm includes a removable portion, and removing the removal portion permits the wheel mounted to the wheel mount to be removed.

In some instances, the pivot tube is rotatable about the arched brace, and rotating the pivot tube changes an angle of the pivot access with respect to a horizontal reference.

In some implementations, a three-wheeled vehicle includes two rear wheels; a front wheel supported by a wheel-mount arm comprising a wheel mount coupled to a pivot tube, the pivot tube configured to pivot about a pivot axis, and the wheel mount configured to permit the front to rotate about a wheel axis; the wheel mount comprising an arched brace comprising a first end, a second end and an apex, wherein the pivot tube is mounted proximal to the apex of the arched brace and defines the pivot axis; a first mounting point at the first end of the arched brace, and a second mounting point at the second end of the arched brace, the first and second mounting points at the same height or lower than the wheel mount; a third mounting point coupled to the arched brace between the first mounting point and the apex, and a fourth mounting point coupled to the arched brace between the second mounting point and the apex, wherein the third and fourth mounting points are configured to be coupled to shock absorbers and wherein the first and second mounting points are configured to be pivotably coupled to the frame of the three-wheeled vehicle.

Implementations can optionally include one or more of the following features.

In some instances, the third and fourth mounting points are on outriggers mounted to the arched brace, and wherein the shock absorbers are mounted to the frame of the vehicle at locations higher than the first and second mounting points.

In some instances, the pivot tube comprises a bearing configured to permit the wheel to pivot about the pivot axis, wherein the bearing is an angular contact bearing configured to withstand both axial and radial loads.

In some instances, the wheel-mount arm is configured to engage a steering column mounted to a top of the pivot tube. In some cases, the wheel mounting arm is a single sided mounting arm.

In some instances, the first and second mounting points define a suspension axis, and wherein the suspension axis is lower than, and behind the wheel axis relative to the vehicle frame.

In some instances, the pivot tube is supported by pivot bearings, and wherein the pivot bearings are angled contact bearings.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a perspective view of a wheel suspension system mounted to the frame of a three-wheeled vehicle.

FIG. 2 is a close up perspective view of a wheel suspension system mounted to the frame of a three-wheeled vehicle.

FIG. 3 is a side view of a wheel suspension system mounted to the frame of a three-wheeled vehicle.

FIG. 4 is a top view of a wheel suspension system.

FIG. 5 is a side view of a wheel and wheel-mounting arm illustrating the use of pivot bearings.

FIG. 6 is a front view of a single sided wheel-mounting arm.

FIG. 7 is a perspective view of a suspension system with a removable wheel mounting arm.

### DETAILED DESCRIPTION

This disclosure describes a suspension system for a wheel on a three-wheeled vehicle. Specifically a singular centrally mounted wheel can be mounted to the frame of a three-wheeled vehicle using the suspension system described here, which provides stable load bearing and enables the wheel to pivot.

Conventional three-wheeled vehicles with a singular front wheel use a front suspension system similar to a motorcycle fork. A wheel is retained between two large shocks, which are in turn mounted to a triple tree structure that pivots at a single rigidly mounted point on the vehicle frame. The system described here includes a wheel-mounting arm that is mounted to a pivot point on an arched brace, which is then pivotably mounted to the vehicle frame at four locations, with shocks between the arched brace and the upper two mounting locations. This results in a wheel mounting system, which allows the wheel to pivot (e.g., turn left or right) without substantially altering the contact patch between the wheel and the pavement. The system described here allows the pivot point of the wheel mount to translate while the suspension compresses (or expands), separating the pivot dynamics of the wheel from the suspension dynamics of the vehicle. Further, mounting the system to the frame of the vehicle at four outer points of the frame provides improved load distribution to the frame, resulting in overall increased strength and allowing for lighter, cheaper components when compared to the singular mounting point of a conventional front suspension system.

The disclosed solution includes one or more of the following additional advantages. This solution allows for simple construction methods, yielding a cost effective solution with easy maintenance. Removable side plates and mounting arms make accessing the front wheel straightforward, and a retained central hub and brake system allows removal and replacement of the wheel without removing the brake disc or bearings. Additionally, the modular nature of the design allows for partial construction and easy assembly, as well as simple replacement of damaged or defective parts.

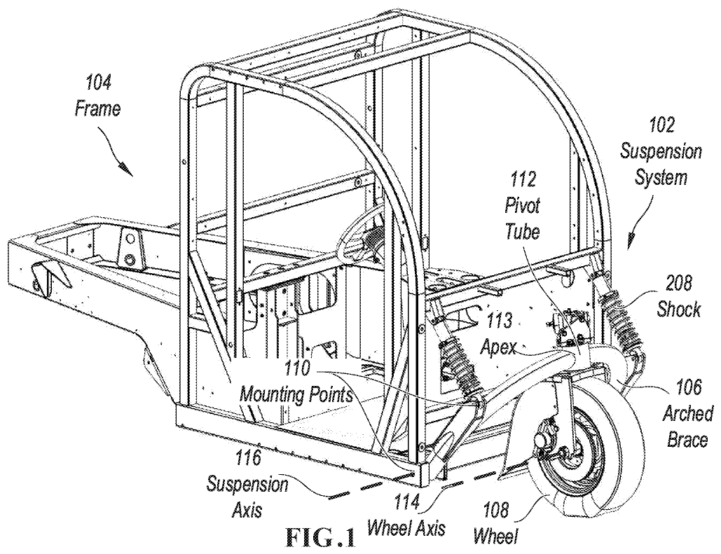

Turning to the illustrated example, FIG. 1 illustrates a perspective view of a wheel suspension system 102 mounted to the frame of a three-wheeled vehicle. The suspension system is mounted to a vehicle frame 104 via mounting points 110.

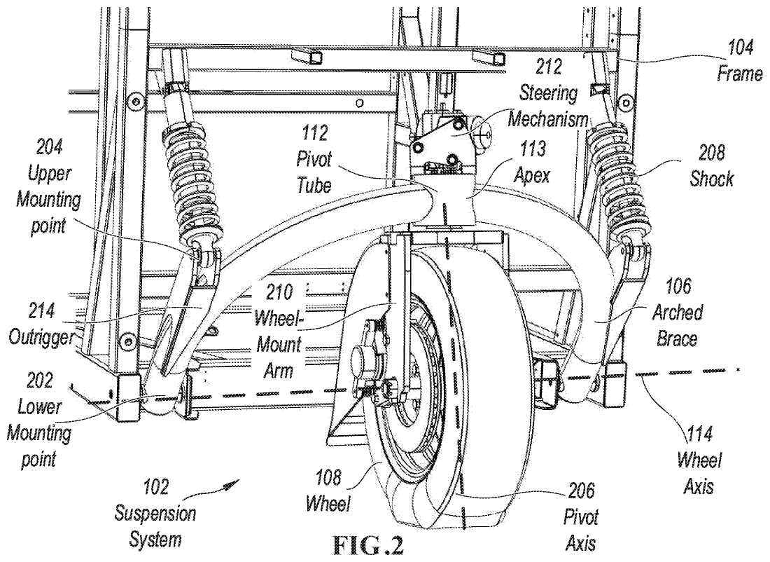

The suspension system 102 includes an arched brace 106, which is pivotably mounted to the frame 104 such that it is able to pivot about a suspension axis 116. The arched brace 106 supports a pivot tube 112 which holds a wheel 108. The pivot tube 112 is located at the apex 113 of the arched brace 106. The wheel rotates about a wheel axis 114, which itself can pivot around the pivot axis (shown and discussed with reference to FIG. 2).

As illustrated in FIG. 1, the mounting points 110 are near the outer sides of the frame 104. This location for the mounting points 110 distributes the loads supported by the suspension system 102 to the edges of the frame 104, permitting simplified structure when compared to a conventional single wheel central mount (e.g., a triple tree). Shocks 208, such as suspension springs, pneumatic shock absorbers, hydraulic shock absorbers, other mechanical dampers, or a combination thereof, are mounted near the outside edges of the frame 104 (between the frame 104 and mounting points 110). These widely mounted shocks 208 provide enhanced roll stability as compared to conventional shocks which are mounted very near the wheel. In general, the shocks 208 distribute reactive road forces and dynamic load forces to the vehicle frame 104. In some implementations, the shocks are mounted between the frame 104 and the arched brace 106 via compressive or elastic bushings, which reduce vibrations and wear between components.

FIG. 2 is a close up perspective view of a wheel suspension system mounted to the frame of a three-wheeled vehicle. The lower mounting points 202 support the arched brace 106 allowing it to rotate about the suspension axis (not shown). In some implementations, the arched brace 106 is mounted to the lower mounting points 202 via compressible or elastic bushings in order to reduce wear and vibrations, and impact loads over time. Outriggers 214 affixed to the side of the arched brace 106 include upper mounting points 204, which are coupled to shocks 208 that transfer load from the upper mounting points 204 to the frame 104. The upper mounting points 204 are between the lower mounting points 202 and the apex 113 of the arched brace 106. The shocks 208 expand and contract allowing the arched brace to pivot about the lower mounting points 202 and the wheel 108 to translate vertically. The length of the outriggers 214 can be adjustable, to allow for angle adjustment of the shocks 208, and modifiable distribution of loads to the frame 104.

A steering mechanism 212 is coupled to the top of the pivot tube 112. The steering mechanism 212 includes mechanisms to rotate a wheel-mount arm 210 and wheel 108 about the pivot axis 206. For example, the steering mechanism 212 can include a worm gear, which engages a pinion, or splines of a pinion that is affixed to the wheel-mount arm 210. A steering column (not shown) can be coupled to the steering mechanism 212 and to a steering wheel of the vehicle to allow a driver to steer the wheel 108. As the wheel 108 pivots about the pivot axis 206 the wheel axis 114 rotates as well, maintaining an orthogonal relationship with the pivot axis 206. One or more position sensors can be integrated into the steering mechanism 212 and can provide input angle sensing or steering angle sensing. For example, one or more Hall Effect sensors, or encoders can be provided in the steering mechanism 212 which can enable automated steering inputs, driver assistance, or other autonomous vehicle applications.

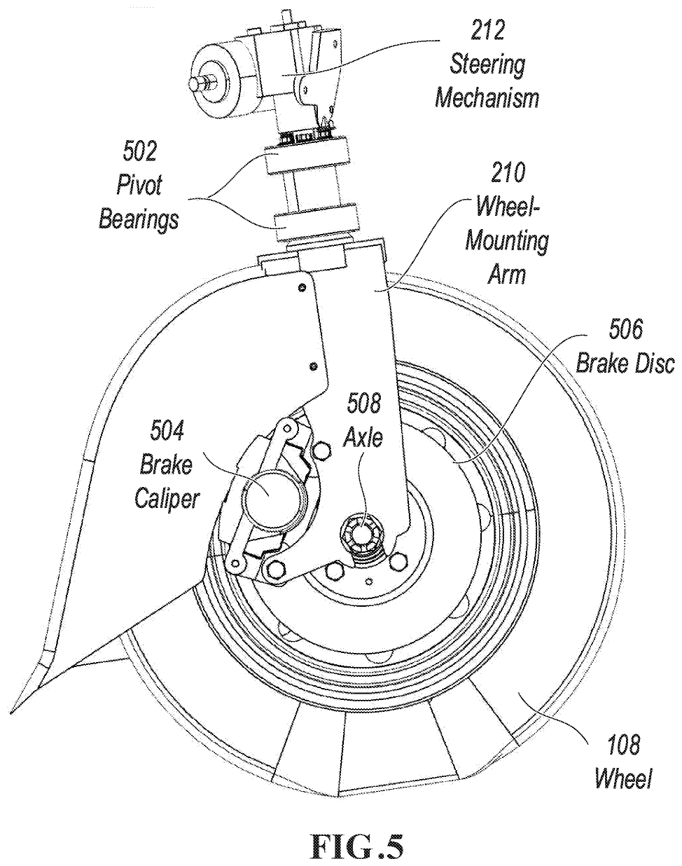

The pivot tube 112 supports the wheel-mount arm 210 and includes bearings (discussed below with reference to FIG. 5) that allow the wheel-mount arm 210 to rotate and transfer loads from the wheel-mount arm 210 to the arched brace 106.

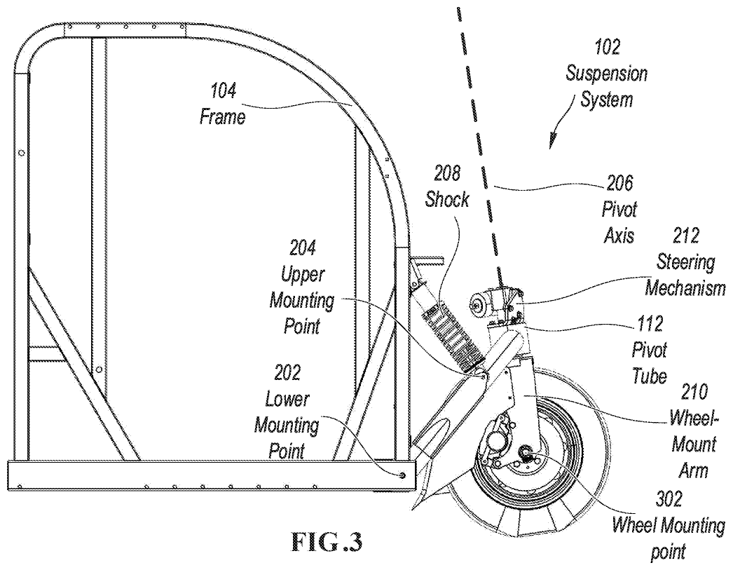

FIG. 3 is a side view of a wheel suspension system mounted to the frame of a three-wheeled vehicle. From the side view, it can be seen that the pivot axis 206 is not directly vertical. Instead, the pivot axis is angled from the vertical; this angle is referred to as a rake angle. In some implementations, the rake angle is between 5 and 15 degrees, and changes as the suspension travels. For example, as the shocks 208 compress and the wheel 108 translates up, the rake angle increases.

The rake angle effectively places the contact patch of the tire behind the rotation point of the tire at the point of contact, causing the wheel to naturally pivot in the direction of vehicle motion. This results in an inherently stable steering mechanism. As the rake angle increases, the “centering” force on the wheel increases. As compared to a conventional fork-and-triple implementation, the suspension system 102 has a significantly reduced rake angle (e.g., 8 degrees as compared to 23-50 degrees). This results in a “lighter” feel at the steering wheel, and less force required operating the steering mechanism.

In some implementations, the pivot tube 112 can be rotated or adjusted in the angle at which it is mounted to the arched brace (e.g., arched brace 106). In this manner, the pivot axis 206 can be altered, altering the rake angle, and allowing for different handling characteristics.

Since the shocks 208 are not mounted directly to the wheel 108, the shock angle is not directly coupled to the rake angle (as it is in a conventional fork-and-triple configuration). As shown in FIG. 3, the shocks are angled at an approximately 35-degree angle from the vertical. This allows the shocks to absorb both vertical and horizontal forces (e.g., potholes, or curb impacts) to the wheel 108. Greater or lesser angles for the shocks are possible, and can be adjusted based on the length of the outriggers 214. For example, shocks 208 at an angle of 45 degrees or 20 degrees are possible. It should also be noted that the shock angle varies as the suspension travels.

The lower mounting points 202 are lower than the center of the wheel 108 or the wheel mounting point 302. In some implementations, the lower mounting points 202 are at the same height as the wheel mounting point 302. By ensuring the lower mounting points 202 are higher than, or at the same height as the wheel mounting points, vehicle stability is increased.

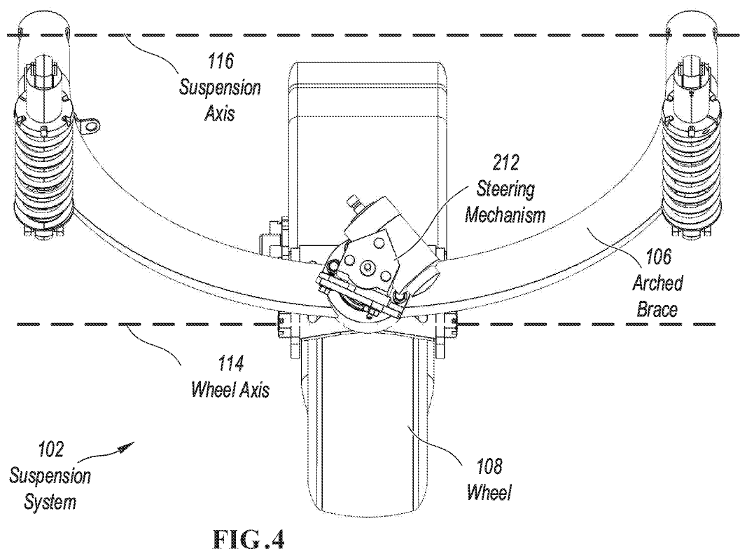

FIG. 4 is a top view of a wheel suspension system. FIG. 4 illustrates that the suspension axis 116 is behind the wheel axis 114 relative to the vehicle. As the wheel 108 pivots to steer, the suspension axis 116 of the suspension system 102 remains unchanged. This provides predictable vehicle dynamics during suspension travel regardless of the steering angle of the wheel 108.

Suspension axis 116 is further lower than or at the same height as the wheel axis 114, as the lower mounting points 202 are lower than the wheel mounting point 302. This provides enhanced stability and load carrying for a three-wheeled vehicle.

FIG. 5 is a side view of a wheel and wheel-mounting arm illustrating the use of pivot bearings. The wheel-mounting arm 210 includes a brake caliper 504, which can provide braking power for the vehicle. In some implementations, the brake caliper 504 is a hydraulic system that engages a brake disc 508. Brake disc 508 can be mounted to a hub that is fixed to the axle 508. The wheel 108 can also be mounted to the hub, which can be retained when the wheel is removed. In some implementations, the brake caliper 504 is a drum style brake, which slows the wheel 108 by engaging a shoe on the rim of the wheel 108. The wheel-mounting arm 210 supports the wheel and transfers loads from the wheel 108, to the arched brace (not shown in FIG. 5) via pivot bearings 502 located in the pivot tube (not shown in FIG. 5). While two pivot bearings 502 are illustrated, fewer, or more pivot bearings 502 are contemplated. The pivot bearings support the wheel-mounting arm 210 in the pivot tube (not shown) and allow the wheel-mounting arm 210 to rotate in response to inputs from the steering mechanism 212. Pivot bearings 502 can be tapered bearings, which are capable of supporting both axial and radial loads. In some implementations, the pivot bearings 502 are angular contact bearings, which have inner and outer ring raceways that are displaced relative to each other in the direction of bearing axis. The displaced raceways allow the bearing to accommodate combined (e.g., axial and radial) loads simultaneously, while having minimal maintenance requirements.

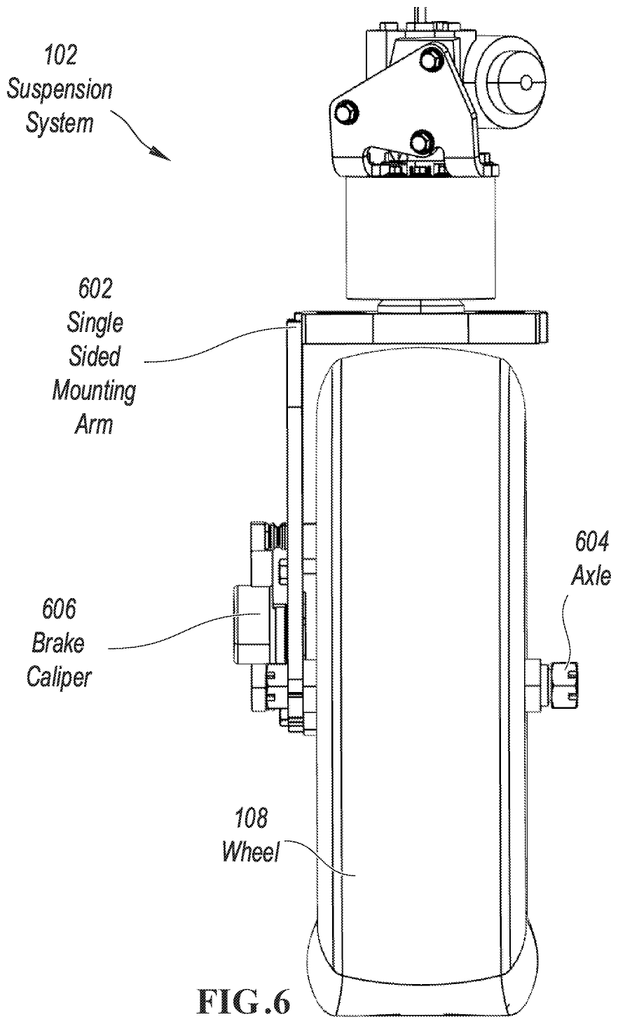

FIG. 6 is a front view of a single sided wheel-mounting arm. In some implementations, a single sided mounting arm 602 is used to support the wheel. A single sided mounting arm 602 is advantageous in that it makes replacing the wheel 108 simpler, reducing maintenance costs and time. An axle 604 and brake caliper 606 are supported on a single side of the wheel by the single sided mounting arm 602.

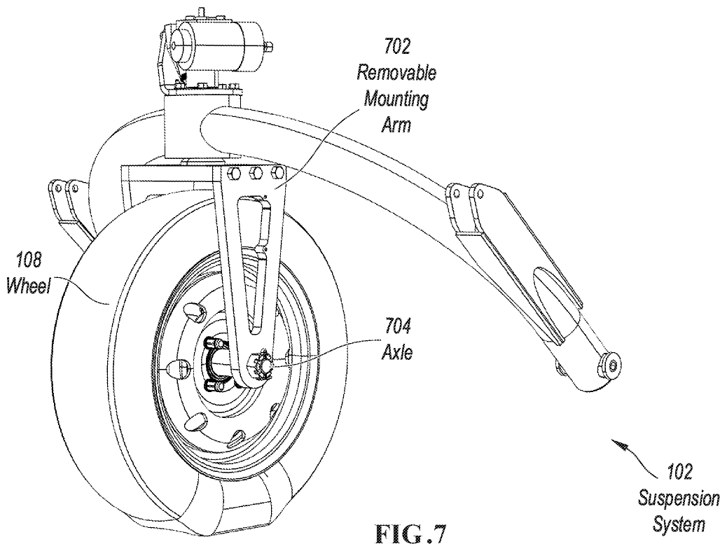

FIG. 7 is a perspective view of a suspension system with a removable wheel mounting arm. In the illustrated implementation, the removable mounting arm 702 is easily removable by removing three nuts located near the top of the removable mounting arm 702. This allows for wheel 108 removable and replacement. When installed, the removable mounting arm 702 ensures the axle 704 is correctly aligned, and distributes load forces from the tire into the suspension system 102. In some implementations, both sides of the wheel mounting arm (e.g., the back side not shown) are similarly removable, allowing for easy removal and maintenance of the entire wheel and hub assembly.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations, but is to be accorded the widest scope consistent with the principles and features disclosed herein.

1. A wheel mounting system comprising:
an arched brace comprising a first end, a second end and an apex;
a pivot tube mounted proximal to the apex of the arched brace and defining a pivot axis;
a wheel-mount arm comprising a wheel mount coupled to the pivot tube, configured to pivot about the pivot axis such that a wheel mounted to the wheel mount will rotate about a wheel axis;
a first mounting point at the first end of the arched brace, and a second mounting point at the second end of the arched brace, the first and second mounting points at the same height or lower than the wheel mount;
a third mounting point coupled to the arched brace between the first mounting point and the apex, and a fourth mounting point coupled to the arched brace between the second mounting point and the apex, wherein the third and fourth mounting points are configured to be coupled to shock absorbers and wherein the first and second mounting points are configured to be pivotably coupled to the frame of a vehicle.

2. The wheel mounting system of claim 1, wherein the third and fourth mounting points are on outriggers mounted to the arched brace, and wherein the shock absorbers are mounted to the frame of the vehicle at locations higher than the first and second mounting points.

3. The wheel mounting system of claim 1, wherein the pivot tube comprises a bearing configured to permit the wheel to pivot about the pivot axis, wherein the bearing is an angular contact bearing configured to withstand both axial and radial loads.

4. The wheel mounting system of claim 1, wherein the wheel is a front wheel, and wherein the vehicle is a three-wheeled vehicle.

5. The wheel mounting system of claim 1, wherein the wheel-mount arm is configured to engage a steering column mounted to a top of the pivot tube.

6. The wheel mounting system of claim 5, wherein the wheel mounting arm is a single sided mounting arm.

7. The wheel mounting system of claim 1, wherein the first and second mounting points define a suspension axis, and wherein the suspension axis is lower than, and behind the wheel axis relative to the vehicle frame.

8. The wheel mounting system of claim 1, wherein the pivot tube is supported by pivot bearings, and wherein the pivot bearings are angled contact bearings.

9. The wheel mounting system of claim 1, wherein the wheel-mount arm comprises a removable portion, wherein removing the removal portion permits the wheel mounted to the wheel mount to be removed.

10. The wheel mounting system of claim 1, wherein the pivot tube is rotatable about the arched brace, wherein rotating the pivot tube changes an angle of the pivot access with respect to a horizontal reference.

11. A three-wheeled vehicle comprising:
two rear wheels;
a front wheel supported by a wheel-mount arm comprising a wheel mount coupled to a pivot tube, the pivot tube configured to pivot about a pivot axis, and the wheel mount configured to permit the front to rotate about a wheel axis;
the wheel mount comprising an arched brace comprising a first end, a second end and an apex, wherein the pivot tube is mounted proximal to the apex of the arched brace and defines the pivot axis;
a first mounting point at the first end of the arched brace, and a second mounting point at the second end of the arched brace, the first and second mounting points at the same height or lower than the wheel mount;
a third mounting point coupled to the arched brace between the first mounting point and the apex, and a fourth mounting point coupled to the arched brace between the second mounting point and the apex, wherein the third and fourth mounting points are configured to be coupled to shock absorbers and wherein the first and second mounting points are configured to be pivotably coupled to the frame of the three-wheeled vehicle.

12. The three-wheeled vehicle of claim 11, wherein the third and fourth mounting points are on outriggers mounted to the arched brace, and wherein the shock absorbers are mounted to the frame of the vehicle at locations higher than the first and second mounting points.

13. The three-wheeled vehicle claim 11, wherein the pivot tube comprises a bearing configured to permit the wheel to pivot about the pivot axis, wherein the bearing is an angular contact bearing configured to withstand both axial and radial loads.

14. The three-wheeled vehicle of claim 11, wherein the wheel-mount arm is configured to engage a steering column mounted to a top of the pivot tube.

15. The three-wheeled vehicle of claim 14, wherein the wheel mounting arm is a single sided mounting arm.

16. The three-wheeled vehicle of claim 11, wherein the first and second mounting points define a suspension axis, and wherein the suspension axis is lower than, and behind the wheel axis relative to the vehicle frame.

17. The three-wheeled vehicle of claim 11, wherein the pivot tube is supported by pivot bearings, and wherein the pivot bearings are angled contact bearings.
